(19) United States
(12) Patent Application Publication
(10) Pub. No.: US 2005/0117222 A1
(43) Pub. Date: Jun. 2, 2005

(54) Precise optical grating element and method of making a stamper thereof

(76) Inventor: Kuo-Chi Chiu, Hsinchu (TW)

Correspondence Address: BIRCH STEWART KOLASCH & BIRCH, PO BOX 747, FALLS CHURCH, VA, 22040-0747, US

(21) Appl. No.: 10/819,140

(22) Filed: Apr. 7, 2004

(30) Foreign Application Priority Data
Nov. 28, 2003 (TW) 092133484

(51) Int. Cl. G02B 27/44

(52) U.S. Cl. 359/566; 359/563

(57) ABSTRACT

A method for making an optical grating element and its stamper is disclosed. The method is modified from the fabrication process of read-only optical disc to form a stamper with an optical grating element structure. Then, using the plastic mold-injection technology with the stamper as a mold to fabricate the precise optical grating element. The optical grating element and the stamper have very fine scales. The optical signal from the optical grating element can be easily read by using a common optical pick-up head that is reliable and resistant to vibration so as to meet the requirements of high precision control systems and overcome the problems of prior arts.

### BACKGROUND OF THE INVENTION

1. Field of the Invention

The invention relates to a precise optical grating element and a method for making a stamper thereof. In particular, it relates to a method for making a precise optical grating element and its stamper through a similar fabrication process of read-only optical disc. In addition, the signal of the optical grating element can be read through a common optical pick-up head.

2. Related Art

An optical encoder, which resolution is determined by the scale of the optical grating element, is composed of an optical grating element and an optical reading device. A finer scale gives a higher resolution. Optical encoders are usually used in the precise control systems for detecting angles, speed or positions.

Conventionally, optical grating elements used in optical encoders are made by plastic mold-injection, machining or semiconductor process.

The optical grating elements made by the plastic mold-injection are easy and low cost, while their fine scale is limited by the precision of tooling and injection. Therefore, they cannot meet the high-resolution requirements to be used in the precise control systems.

The optical grating elements made by machining are also limited to the precision of machining and the fine scale of optical grating elements can not be obtained. As a result, they cannot be used in the high-precision control systems as well. Further, machining is not optimal for mass production, and the cost is high.

Semiconductor process for making the optical grating elements is illustrated in FIGS. 1A to 1G. First, in FIG. 1A, a glass or metal substrate is provided with a flat surface after polishing. Then, the surface is cleaned to be free from dusts.

In FIG. 1B, a photoresist layer is coated on the surface of the substrate, then, heated and cured there, as shown in FIG. 1C, through a curing process.

Then, in FIG. 1D, using a photomask, which carries an optical grating pattern, on the substrate to expose and transfer the optical grating pattern onto the surface of the substrate after developing, as shown in FIG. 1E.

Further, in FIG. 1F, depositing a metallic film on the surface of the substrate as a reflective layer through a sputtering or evaporating process. The reflective layer makes the optical grating pattern readable by light beam. Then, coating a protective layer on the substrate to protect the optical grating element, as shown in FIG. 1G.

Though the aforesaid semiconductor process can produce the optical grating element with fine scales to meet the high-resolution requirements, the optical signal is weak that a highly precise optical reading device is necessary for reading the weak signal. The delicate structure makes the product expensive and hard for mass production. Moreover, the optical signal is weak and sensitive to vibration that usually causes reading failure. In order to read the weak signal of the optical grating element, a complicated optical reading device including lens, mirrors and prisms, etc., such as that disclosed in U.S. Pat. No. 4,829,342 and U.S. Pat. No. 4,868,385, is required. However, it costs very high and is difficult in alignment and sensitive to vibration.

### SUMMARY OF THE INVENTION

The object of the invention is to provide a new method for making an optical grating element and its stamper. The method is modified from the fabrication process of read-only optical disc. The optical grating element and the stamper have fine scales suitable for being used in the high-resolution control systems while resistant to vibration conditions.

The stamper can be used as a mold for the plastic injection so that optical grating elements can be easily made through the mold-injection and deposition process. Mass production is possible and cost less. Further, the optical grating element made from the stamper has fine patterns similar to that made by semiconductor process and gives high resolution. Besides, the weak signal from the optical grating element can be easily read using a common optical pick-up head. The common optical pick-up head is reliable and resistant to vibration so as to meet the requirements of high precision control systems and to overcome the problems of prior arts.

A comparison among fabrication processes of mold-injection, machining, semiconductor process and read-only optical disc process for optical grating elements is listed as follows.

| | Characteristics | | | | |
|---|---|---|---|---|---|
| | | | | Mass | Reading |
| Different process | Process | Resolution | Price | production | device |
| Plastic mold-injection | Easy | Low | Low | Easy | Simple |
| Machining | Easy | Low | High | Difficult | Simple |
| Semiconductor process | Difficult | High | Expensive | Difficult | Complicated |
| Read-only optical disc process | Easy | High | Low | Easy | Simple |

From the table, it is clear that the optical grating element made by using the read-only optical disc process of the invention has easy process, high resolution, low cost, easy for mass production and the optical reading device is simple and reliable.

The prior arts of making a read-only optical disc include the following steps. First, polishing a glass substrate to get a flat surface. Washing and removing dusts from the surface of the substrate. Then, coating a photoresist layer on the surface of the substrate. Heating and curing the photoresist layer. Further, using a high power laser to write data patterns into a spiral track on the substrate. Forming the data patterns on the substrate through a developing process. Then, depositing a metallic film as an electrically conductive layer on the substrate through a sputtering or evaporating process. Further, electroplating the substrate to increase the thickness of the metallic film and forming a metallic plate. Then, separating the metallic plate from the substrate. The metallic plate carries the reversed patterns of the data patterns on the substrate. Cleaning the metallic plate, polishing its back, punching the central hole and removing the circumference excessive portion to finish a stamper for making the read-only optical disc.

When making a read-only optical disc, the stamper is used as a mold for the plastic injection and getting a plastic substrate having a correspondent pattern to that of the stamper. Then, the plastic substrate is coated with a metallic film as a reflective layer so that a laser beam can read the data patterns from the optical disc. Finally, a protective layer is formed on the optical disc to finish a common read-only optical disc. The fabrication process is inexpensive because the plastic mold-injection is easy and suitable for mass production.

The fabrication process of the invention is similar to that of making a read-only optical disc. But before the developing process, a photomask with the optical grating patterns is used for exposure to transfer the optical data patterns onto the substrate instead of using a laser beam to write the spiral data patterns. Finally, a stamper of optical grating element is made through the rest procedures as described above for making a stamper of read-only optical disc.

When making an optical grating element, the stamper is used as a mold for the plastic injection and getting a plastic substrate having a correspondent pattern to that of the stamper. Then, the plastic substrate is coated with a metallic film as a reflective layer so that a laser beam can read the data pattern from the optical disc. Finally, a protective layer is formed on the optical disc to finish an optical grating element.

The optical grating element made by the invention has fine scales for being used in the precise control systems. Though the optical signals are weak, they can be read using a common optical pick-up head so that no special or complicated reading device is needed. The current optical disc technology is well developed, and the optical pick-up head can read very small signals. For example, the track size of 1.6 μm in CD has been reduced to 0.74 μm in DVD, and has been further reduced to 0.32 μm in blu-ray disc. The common optical pick-up heads are adequate for reading the weak signals of the optical grating element accordingly and they are reliable and low-cost.

Moreover, the focal lens in the optical pick-up head can be finely adjusted by using an actuator when the focus of reading is not well aligned. The fine adjustment helps the optical grating element free from the poor signal problems caused by uneven surface or vibration. Therefore, using the optical pick-up head is the only way to prevent from the vibration problem of prior arts.

The optical grating element made by using the read-only optical disc fabrication process of the invention has fine scales suitable for optical encoders and meets the high-resolution requirements of precise measuring systems. Common inexpensive and practical optical pick-up head can be used for reading the weak signals of the optical grating element.

The optical grating element is also applicable to a sliding mechanism and used as a control element of precise displacement.

### BRIEF DESCRIPTION OF THE DRAWINGS

The invention will become more fully understood from the detailed description given hereinbelow. However, this description is for purposes of illustration only, and thus is not limitative of the invention, wherein:

FIGS. 1A to 1G are sequential views of a semiconductor fabrication process for making an optical grating element;

FIGS. 2A to 2L are sequential views of a modified read-only optical disc fabrication process for making a stamper of optical grating element;

FIGS. 3A to 3E are sequential views of a fabrication process of mold-injection and film-deposition for making an optical grating element from a stamper made by using the process of the invention;

FIGS. 4A to 4D are sequential views of a fabrication process of mold-injection, film-deposition and adhesion for making an optical grating element from a stamper made by using the process of the invention; and

FIGS. 5A and 5B are examples of photomask patterns for making different kinds of optical grating elements.

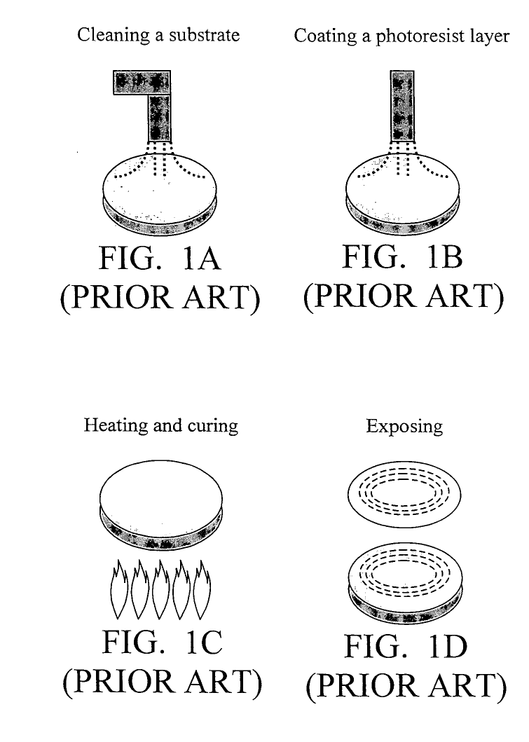

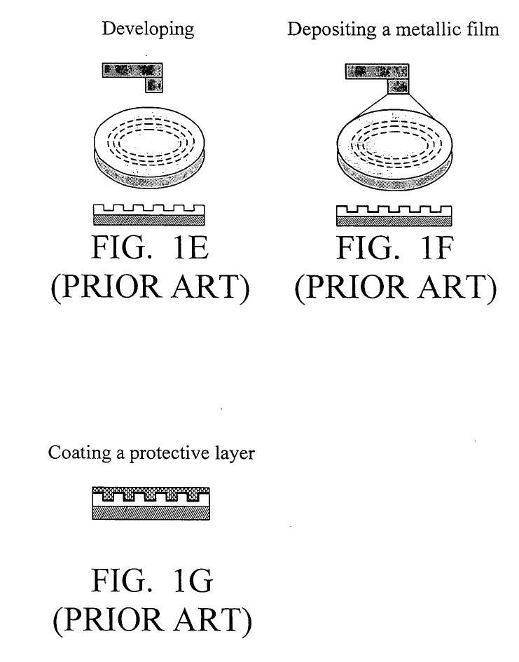

### DETAILED DESCRIPTION OF THE INVENTION

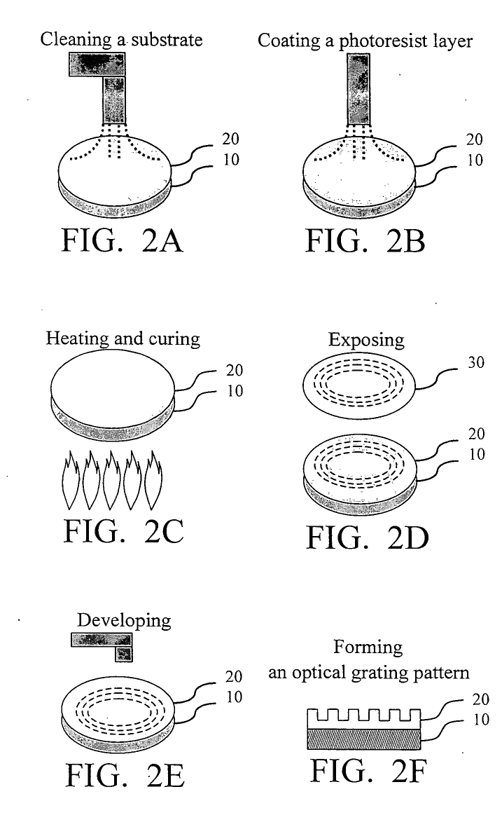

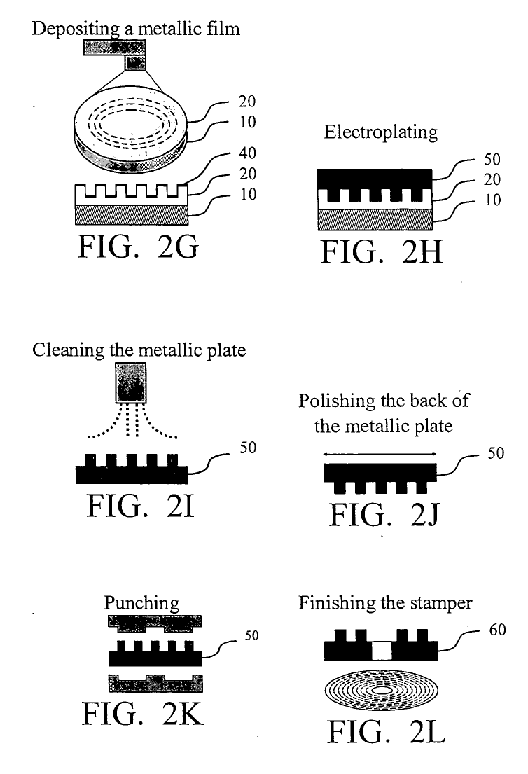

FIGS. 2A to 2L are sequential views of a modified read-only optical disc fabrication process of the invention for making a stamper of optical grating element. First, in FIG. 2A, polishing a glass substrate 10 to get a flat surface. Washing and removing dusts from the surface of the substrate 10. Then, in FIG. 2B, spin-coating a photoresist layer 20 on the surface of the substrate 10. Heating and curing the photoresist layer 20 on the substrate 10, as shown in FIG. 2C. Further, in FIG. 2D, a photomask 30 with an optical grating pattern is used for light exposure so that the optical grating pattern is transferred to the substrate 10. In FIG. 2E, forming an optical grating pattern on the substrate 10 through a developing process and removing excessive photoresist layer 20. The optical grating pattern is correspondent to the shape and resolution of the photomask 30. As shown in FIG. 2F, an optical grating pattern is formed. Then, in FIG. 2G, depositing a metallic (usually nickel) film 40 as an electrically conductive layer on the substrate 10 through a sputtering or evaporating process. Further, in FIG. 2H, electroplating the substrate 10 to increase the thickness of the metallic film 40 and forming a metallic plate 50. Then, in FIG. 21, separating the metallic plate 50 from the substrate 10. The metallic plate 50 carries a reversed pattern of the optical grating pattern on the substrate 10. Further, in FIG. 2J, cleaning the metallic plate 50, polishing its back, punching the central hole and removing the circumference excessive portion, as shown in FIG. 2K, to finish a stamper, as shown in FIG. 2L, for making the optical grating elements.

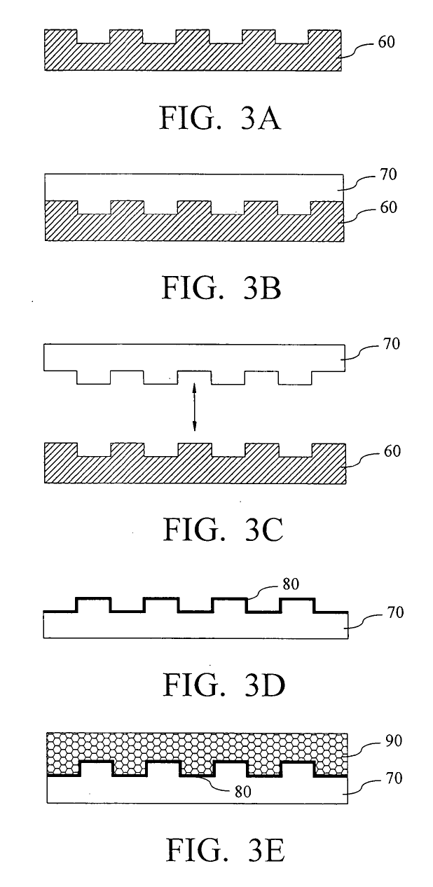

FIGS. 3A to 3E are sequential views of a fabrication process of mold-injection and film-deposition for making an optical grating element from a stamper made by using the process of the invention.

As shown in FIG. 3A, when making an optical grating element, the stamper 60 is used as a mold for the plastic injection and getting a plastic substrate 70 as shown in FIG. 3B. The plastic substrate 70 is made of a polycarbonate with the thickness of 0.6 to 5 mm. Then, in FIG. 3C, the plastic substrate 70 having a correspondent pattern to that of the stamper 60 is separated from the stamper 60. In FIG. 3D, the plastic substrate 70 is coated with a metallic film 80 as a reflective layer so that a laser beam can read the data signals from the plastic substrate 70. The metallic film 80 is usually made of an aluminum having a reflectivity over 35%. Finally, in FIG. 3E, a protective layer 90 is formed through spinning coating on the metallic film 80 to finish an optical grating element. The material of the protective layer 90 is an acrylic photocurable resin.

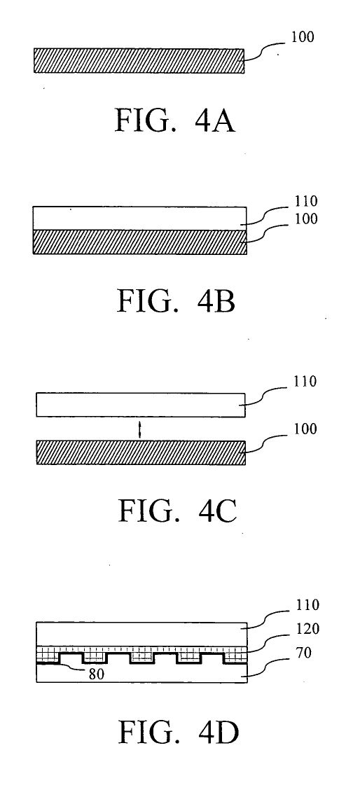

As shown in FIGS. 4A to 4D, the optical grating element can also be made by adhesion. First, in FIG. 4A, making a blank stamper 100 by using a similar process of the aforesaid read-only optical disc fabrication process. Then, in FIG. 4B, using the blank stamper 100 as a mold for the plastic injection and getting a plastic blank substrate 110. The blank substrate 110 is made of a polycarbonate with the thickness of 0.6 to 5 mm. Then, in FIG. 4C, the blank substrate 110 is separated from the blank stamper 100. In FIG. 4D, adhering the blank substrate 110 to a plastic substrate 70 with a metallic film 80 made from the aforesaid process of FIG. 3D and finishing the optical grating element. The optical grating element made by adhesion is stronger than that made with a protective layer through spinning coating.

The optical grating element made by using the read-only optical disc fabrication process of the invention has fine scales suitable for optical encoders and meets the high-resolution requirements of precise measuring systems. The optical grating element is also applicable to a sliding mechanism and used as a control element of precise displacement.

As the optical grating element of the invention being made through the read-only optical disc fabrication process, the weak signals of optical grating element can be read using a common optical pick-up head. In comparison with the complicated optical reading system composed of lens, mirrors and prisms, etc., for reading the fine scale in prior arts. The common optical pick-up head is adequate for optical grating elements of the invention in reading data and it is practical, inexpensive and convenient.

Moreover, the focal lens in the optical pick-up head can be finely adjusted by using an actuator when the focus of reading is not well aligned. The fine adjustment helps the grating element free from the poor signal problems caused by uneven surface or vibration. Therefore, using the common optical pick-up head is the only way to prevent from the vibration problem of prior arts.

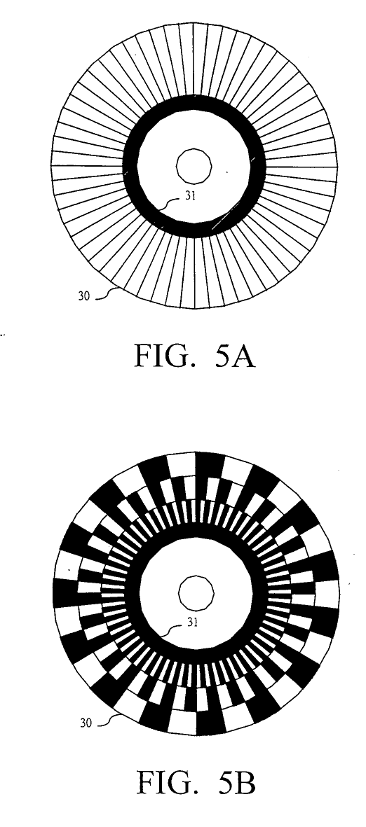

FIGS. 5A and 5B are examples of photomask patterns 30 for making different kinds of optical grating elements. The photomask pattern 30 in FIG. 5A has a single scale so that an optical grating element made form it has a fixed fine scale. While, in FIG. 5B, the photomask pattern 30 has multiple scales so that an optical grating element made form it has multiple scales. Users can choose the different scale regions for different needs and expand the applications of an optical encoder.

In the photomask patterns 30 of FIGS. 5A and 5B, there is a circular reflective region 31 at the center of the patterns. The reflective region 31 has no optical grating patterns but a plane for checking the performance of the laser diode in the optical pick-up head. When the laser diode decays, the reflection from the reflective region 31 decreases and indicates that the laser diode has to be replaced. Therefore, there is no need to use additional components for calibration of the laser source. The reflective region 31 is not necessarily at the center portion. It can be located at the circumference, for example.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

1. A fabrication process for making a stamper of optical grating element, comprising following steps of:
providing a substrate;
coating a photoresist layer on a surface of said substrate;
heating and curing said photoresist layer on said substrate;
exposing said substrate through a photomask with an optical grating pattern, to transfer said optical grating pattern onto said substrate;
developing said substrate to remove a part of said photoresist layer to form an optical grating pattern on said substrate;
depositing a metallic film on said substrate as an electrically conductive layer for electroplating;
electroplating said substrate to increase the thickness of said metallic film and forming a metallic plate; and
separating said metallic plate from said substrate; said metallic plate is a stamper with a reversed pattern of said optical grating pattern on said substrate.

2. The fabrication process for making a stamper of optical grating element according to claim 1 wherein material of said substrate is selected from a group consisting of glass and metal.

3. The fabrication process for making a stamper of optical grating element according to claim 1 wherein said photomask comprises a plane reflective region for forming a laser source checking region on said optical grating element.

4. The fabrication process for making a stamper of optical grating element according to claim 1 wherein said photomask has a single scale so as to form said grating element with a fixed fine scale.

5. The fabrication process for making a stamper of optical grating element according to claim 1 wherein said photomask has multiple scales so as to form said optical grating element with multiple scales.

6. The fabrication process for making a stamper of optical grating element according to claim 1 wherein said step of depositing a metallic film on said substrate is through sputtering.

7. The fabrication process for making a stamper of optical grating element according to claim 1 wherein said step of depositing a metallic film on said substrate is through evaporating.

8. The fabrication process for making a stamper of optical grating element according to claim 1 wherein material of said metallic film is nickel.

9. An optical grating element, comprising:
a plastic substrate, having an optical grating pattern formed on a surface thereof;
a metallic film, formed on said plastic substrate as a signal reflective layer; and
a protective layer, formed on said metallic film.

10. The optical grating element according to claim 9 wherein said plastic substrate is made through a mold-injection process by using a stamper of optical grating element.

11. The optical grating element according to claim 10 wherein said stamper of optical grating element is made through steps of:
providing a substrate;
coating a photoresist layer on a surface of said substrate;
heating and curing said photoresist layer on said substrate;
exposing said substrate through a photomask with an optical grating pattern, to transfer said optical grating pattern onto said substrate;
developing said substrate to remove a part of said photoresist layer to form an optical grating pattern on said substrate;
depositing a metallic film on said substrate as an electrically conductive layer for electroplating;
electroplating said substrate to increase the thickness of said metallic film and forming a metallic plate; and
separating said metallic plate from said substrate; said metallic plate is a stamper with a reversed pattern of said optical grating pattern on said substrate.

12. The optical grating element according to claim 9 wherein material of said plastic substrate is a polycarbonate.

13. The optical grating element according to claim 9 wherein said plastic substrate has a thickness around 0.6 mm to 5 mm.

14. The optical grating element according to claim 9 wherein said metallic film is made through sputtering.

15. The optical grating element according to claim 9 wherein said metallic film is made of an aluminum.

16. The optical grating element according to claim 9 wherein said metallic film has a reflectivity over 35%.

17. The optical grating element according to claim 9 wherein reflective signal from said metallic film is read by using an optical pick-up head.

18. The optical grating element according to claim 9 wherein said protective layer is formed through spinning coating on the metallic film.

19. The optical grating element according to claim 18 wherein said protective layer is made of an acrylic photocurable resin.

20. The optical grating element according to claim 9 wherein said protective layer is adhered to said metallic film.

21. The optical grating element according to claim 20 wherein said protective layer is a blank plastic substrate.

22. The optical grating element according to claim 21 wherein material of said blank plastic substrate is a polycarbonate.

23. The optical grating element according to claim 21 wherein said blank plastic substrate has a thickness around 0.6 mm to 5 mm.
